(19) United States
(12) Patent Application Publication
(10) Pub. No.: US 2023/0061471 A1
(43) Pub. Date: Mar. 2, 2023

(54) MARINE PIPELINE INSTALLATIONS

(71) Applicant: ROYAL IHC LIMITED, Stocksfield, Northumberland (GB)

(72) Inventors: Michael John WATCHORN, Stocksfield (GB); Michael James SMITH, Stocksfield (GB)

(73) Assignee: ROYAL IHC LIMITED, Stocksfield, Northumberland (GB)

(21) Appl. No.: 17/766,972

(22) PCT Filed: Sep. 1, 2020
(86) PCT No.: PCT/EP2020/074285

§ 371 Date: Apr. 6, 2022

(30) Foreign Application Priority Data
Oct. 23, 2019 (NL) 2024088

(51) Int. Cl. B65H 49/32; B63B 35/03; B65H 49/24; F16L 1/20

(52) U.S. Cl. CPC B65H 49/325; B63B 35/03; B65H 49/24; F16L 1/207; F16L 1/205; B65H 2701/1842

(57) ABSTRACT

A reel support apparatus (100) for supporting a pipeline storage reel (102) on a vessel (104) is disclosed. A method for supporting a pipeline storage reel (102) on a vessel (104) using the reel support apparatus (100) is also disclosed. The reel support apparatus (100) comprises a hub body (112) for locating within a hollow central bore (140) of a pipeline storage reel (102) and a plurality of discrete roller elements (114), spaced apart at locations on an outer surface of the hub body (112). In use, a pipeline storage reel (102) is supported by the plurality of discrete and spaced apart roller elements (114).

### TECHNICAL FIELD

The present invention relates to marine pipeline installations. In particular, but not exclusively, the present invention relates to a reel support apparatus for supporting a pipeline storage reel on a vessel.

### BACKGROUND TO THE INVENTION

Traditionally, pipelines may be deployed from a vessel and onto the seabed as a continuous pipe length using various techniques. In “reel-lay” systems, rigid or flexible pipeline is wound onto one or more reels for storage. In use, the pipeline is unwound from the reel and typically fed via a pipeline guide, a pipeline launch tower, and accessories such as tensioners and clamps, towards the seabed. The reel-lay technique can be used to lay pipeline at shallow or deep water depths, of say around 750 m to 1000 m, but could practically be up to 2250 m or more.

As shown in FIG. 1, a vessel 1 for laying pipeline may include a reel 2 and a vertical lay tower 3. On the reel 2, a steel pipe, which has been welded on shore is spooled. The pipe may have a length of about 100 km and may weigh about 5000 to 6000 tonnes. The pipe is fed along a first trajectory 4 to the lay tower 3 and passes from thereon vertically downward to the seabed along a second trajectory 5. The pipe passes over a deflection member 6, which may include a tension compensator having a curved arm or pipe aligner 7, which is attached to a frame 10.

The reel 2 is driven by a schematically indicated drive means 12. It is, however also possible to unwind the reel 2 by the weight of the pipe length depending from the lay tower and to control rotation of the reel by engaging a brake with a braking surface of the reel 2. In the lay tower 3, the vertical pipe length is carried by tensioners, which clampingly engage the pipe along the vertical trajectory 5.

Typically, as shown schematically in FIGS. 2a and 2b, the reel 2 itself includes a central core 13 for winding pipeline onto, and a flange 19 at each end of the core 13 to help retain the pipeline in place. The reel 2 has a horizontal axis of rotation, as can be seen in the example of FIG. 1 (whereas a carousel has a vertical axis of rotation). The reel 2 may have a flange with a diameter of about 30 m, and a core with a diameter of from about 16 m to about 21 m, for example. Reels may store up to 5000 to 6000 tonnes or more of pipe product. Such reels may be mounted to the deck of a vessel, often set partially within a receiving space below the deck level (as in FIG. 1). As shown in FIG. 2c, a reel support structure 71 extends outwards from each flange of the reel, along the reel's horizontal axis. The pair of support structures 71 each include a housing 73, within which is housed a bearing (for example a rolling-element bearing, not visible in FIG. 2c). The housing 73 sits on a suitable support area on the vessel deck. The bearing allows the reel to rotate along its horizontal axis with respect to the fixed support area on the deck.

Similar reels can also be used for other elongate products, such as subsea cables, umbilicals, flexible flow lines and the like.

Over time, there has been a need to increase the capacity of a reel for holding pipeline, to meet the growing demands for laying pipeline that is longer, larger, and heavier. In some known arrangements, as the mass of the reel increases, combined with the forces conveyed by a moving vessel at sea (vessel roll, pitch and heave motions), the bearings are pushed to the limit by complex load and reaction combinations. Bearing damage or bearing failure known as false brinelling can occur, in which wear causes local deformation of a bearing surface. It is not possible to replace a bearing when the vessel is at sea, causing delays and cost implications to a project.

One way to help mitigate against the risk of false brinelling failure during the transit of the pipeline to its intended destination is to turn the reel at regular time intervals (e.g. turning the reel anything up to 180 degrees at a period of every 24 hours). However, this can also be problematic because the pipeline is typically wound on the reel under tension with the end of the pipeline needing restraint to avoid unwinding of the pipeline. It is usual to attach the end of the pipeline to a part of the vessel. This means it is not possible to regularly turn the reel. Alternatively the end of the pipeline could be attached to the reel itself. However, this is difficult and time consuming. Also, even then, during the transit time, it would be preferable to be able to have the pipeline set up and generally in position (extending over the tower) ready to start laying the pipeline as soon as the destination is reached, again to avoid time delay and related cost implications.

WO2016/042071 and EP3097009 disclose structures for storing elongate structures such as pipeline, cables and flexible flow lines.

### SUMMARY OF THE INVENTION

According to a first aspect of the present invention there is provided a reel support apparatus for supporting a pipeline storage reel on a vessel, comprising:
a hub body for locating within a hollow central bore of a pipeline storage reel,
a plurality of discrete roller elements, spaced apart at locations on an outer surface of the hub body,
wherein, in use, a pipeline storage reel is supported by the plurality of discrete and spaced apart roller elements.

This provides a support distribution to the pipe storage reel that substantially alleviates lateral forces applied into the central bore of the reel and that can, eventually, cause malfunction of the pipe storage reel. Thus, these discrete rollers provide a controlled movement of the pipe storage reel, while the burden of having all the lateral and other applying forces distributed around the outer surface of the hub body, is alleviated.

Aptly, the plurality of roller elements includes at least one array of roller elements, positioned around an upper face of the hub body.

Advantageously, this provides a number of mating surfaces around the upper face of the hub body that contributes to a roller running surface. In this manner, the load of the pipeline storage reel is distributed throughout the whole reel support apparatus and the load is not focused in one point only. In addition, these roller elements assist the pipeline storage reel to move in a controlled manner.

Aptly, the at least one array of roller elements is positioned in an arc configuration.

Aptly, the plurality of roller elements comprising side roller elements, positioned around a side face of the hub body and spaced apart from the at least one array of roller elements.

Aptly, the reel support apparatus further comprises at least one transverse roller element configured to support the reel against vessel roll forces.

This provides a steady structure wherein the vertical translations may be prevented. This is an unwilling translation mainly because these translations will provide lots of instability when the apparatus is on the vessel.

Aptly, at least one of the plurality of roller elements is supported by a support element that is extendable or retractable to different positions.

Advantageously, this provides expandable and collapsible structures that can support substantial loads while also remaining substantially rigid under a variety of conditions. Such structures can be particularly useful in supporting or conveying heavy loads.

Aptly, the support element is a mechanical support, comprising a fixed mount, a screw jack, a wedge, a spring or a hydraulic actuator.

Aptly, the reel support apparatus further comprising a support face adjacent to each roller element of the at least one array, wherein the support face is configured to support the pipeline storage reel when the support element of the corresponding roller element is in a retracted position.

In this manner, the load of the pipeline storage reel is distributed throughout the whole reel support apparatus and the load is not focused in one point only.

Aptly, the reel support apparatus further comprises drive means configured to rotate the pipeline storage reel.

This makes the risk of unexpected overload to have a lower significance of damage of the parts involved.

Aptly, the drive means includes a plurality of drive motors mounted on a mounting element, the mounting element being connected to the vessel.

This allows a better load share with less risk of overload.

Aptly, the reel support apparatus further includes a central bearing, centrally provided within the hub body at a distance from the roller elements.

This reduces the magnitude of the force needing to carried by the roller elements, central bearing and/or other parts.

According to a second aspect of the present invention there is provided a system for storing marine pipeline on the deck of a vessel, comprising:
a storage reel for storing marine pipeline, the reel comprising a hub and flanges at each end; and
a reel support apparatus according to the first aspect of the invention,
wherein the hub body of the reel support apparatus is provided within a hollow central bore of the storage reel, the storage reel being supported by the roller elements of the reel support apparatus.

Advantageously, the system through the storage reel and the hub body area can be more easily closed from a water flooding, reducing the volume of the storage reel well in damage stability. Additionally, the system volume is reduced significantly, and the extra space, when compared with known systems, can be used for other operational or vessel purposes in an area of the vessel with high value in additional space terms. As an example, ROV hangers can be mounted in each end of the support structure giving a fully integrated ROV space with access to both sides of the vessel at the storage reel well location.

According to a third aspect of the present invention there is provided a vessel including the system as described in the second aspect of the invention.

According to a fourth aspect of the present invention there is provided a method of supporting a pipeline storage reel on a vessel, the method comprising:
providing a reel support apparatus according to the first aspect of the invention;
mounting the hollow central bore of a pipeline storage reel onto the hub body of the apparatus, the pipeline storage reel being supported by the plurality of discrete and spaced apart roller elements.

Certain aspects provide the advantage that a reel assembly is provided that has improved resistance to wear or damage compared to known reels. For example, the above aspects may help avoid the failure known as false brinelling. The arrangement may also avoid the need for regular turning of the reel while the vessel is travelling, and the associated problems that can bring.

Certain aspects provide the advantage that some or various individual roller elements may be repaired while at sea, if necessary. Thereby, the reel assembly may be maintained while out at sea, which has previously not been possible.

Certain aspects provide the advantage that a reel arrangement is provided that is more cost effective compared to other known arrangements.

As used herein, it would be understood that an ‘upper face’ refers to a face visible or accessible from above in an operational configuration (i.e. when in use). For example, when referring to a hub body, which may or may not have a continuous surface (for example a substantially cylindrical surface), the upper face is the upward facing face of the outer surface of the hub body, or the portion of the outer surface visible from above, as positioned when assembled on a vessel.

Similarly it would be understood that a ‘side face’ refers to a face visible or accessible from a side in an operational configuration. For example, when referring to a hub body, the side faces are those visible fore and aft (or in front or behind) to the hub body, as positioned when assembled on a vessel.

As used herein, it would be understood that ‘discrete’ refers to something that is distinct or individually separate. For example, ‘a plurality of discrete roller elements spaced apart at locations on an outer surface of the hub body’ refers to a plurality of separate, independent roller elements, each roller element being spaced from adjacent roller elements on an outer surface of the hub body.

As used herein ‘spaced apart circumferentially around a surface’, refers to a spacing around a circumference (for example around the circumference of a substantially cylindrical hub body) within a common axial plane. When referring to a non-cylindrical hub body (for example a hub body that approximates a cylinder, such as a prism or similar) it would be understood that this refers to a spacing around the periphery of the hub body within a common axial plane. It would be understood that an axial plane of the hub body is a plane normal to its longitudinal axis (i.e. the axis configured to be coaxial with the reel axis, around which the pipe is wound). In general the axis of the hub body is horizontal and perpendicular to the longitudinal axis of the vessel.

As used herein, it would be understood that ‘an outer surface of the hub body’ incorporates an outer surface of a mounting frame or track incorporated as part of the hub body. That is, roller elements mounted on a mounting frame or track, are still considered to be positioned at locations on an outer surface of the hub body.

### BRIEF DESCRIPTION OF THE DRAWINGS

Embodiments of the invention are further described hereinafter with reference to the accompanying drawings, in which:

FIG. 1 illustrates a known pipe laying vessel;

FIGS. 2a and 2b illustrate a known pipeline storage reel from a perspective view and side view, respectively;

FIG. 2c illustrates a side view of a known support structure for a pipeline storage reel;

FIG. 3 illustrates a perspective view of a part of a vessel including a reel support apparatus;

FIG. 4 illustrates a perspective view of the part of a vessel of FIG. 3, also including a reel;

FIG. 5a illustrates a side view of a drive means mounting element;

FIGS. 5b and 5c illustrates the drive means mounting element mounted on the reel support apparatus of FIG. 3;

FIG. 6 illustrates a plan view of the reel support apparatus of FIG. 3;

FIG. 7 illustrates a side view of the reel support apparatus of FIG. 3; and

FIG. 8 illustrates a side view of an example of a roller element.

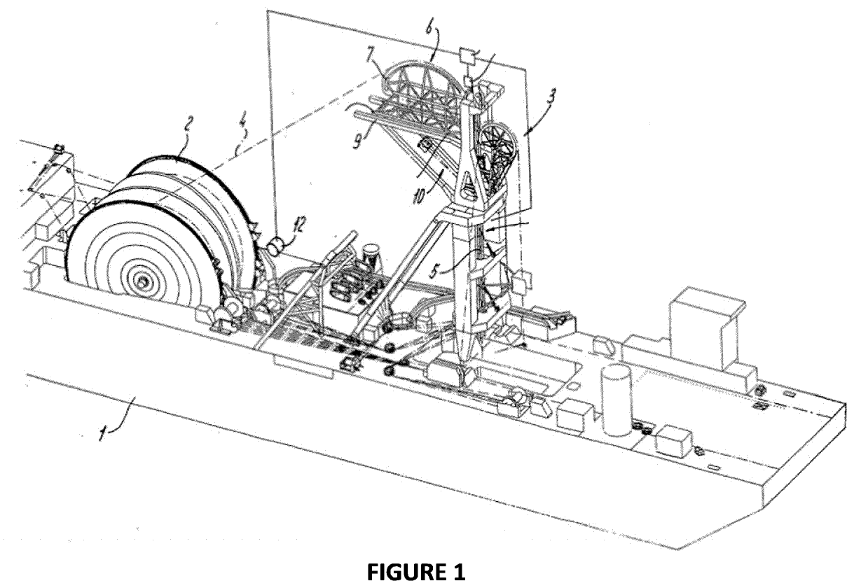

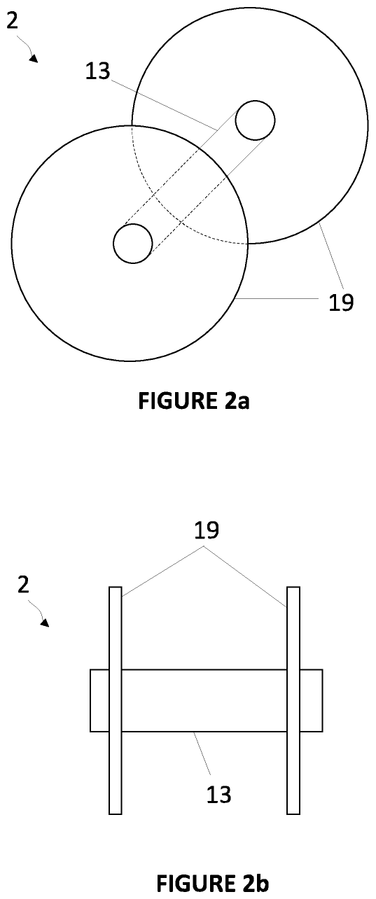

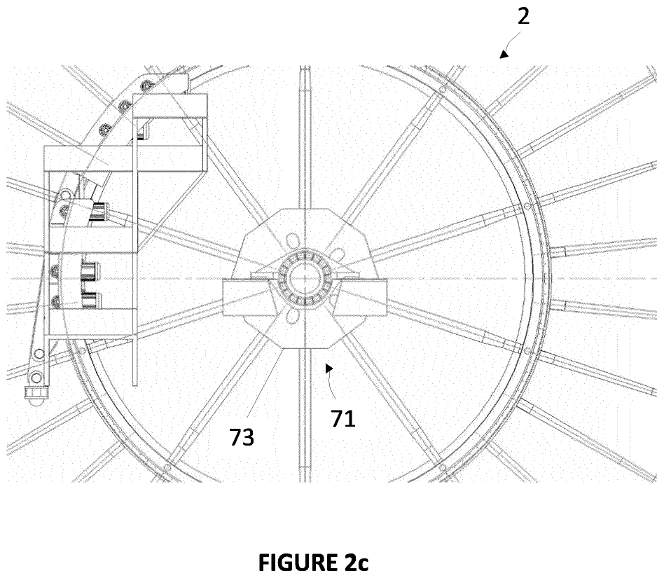

In the drawings like reference numerals refer to like parts.

### DETAILED DESCRIPTION OF THE INVENTION

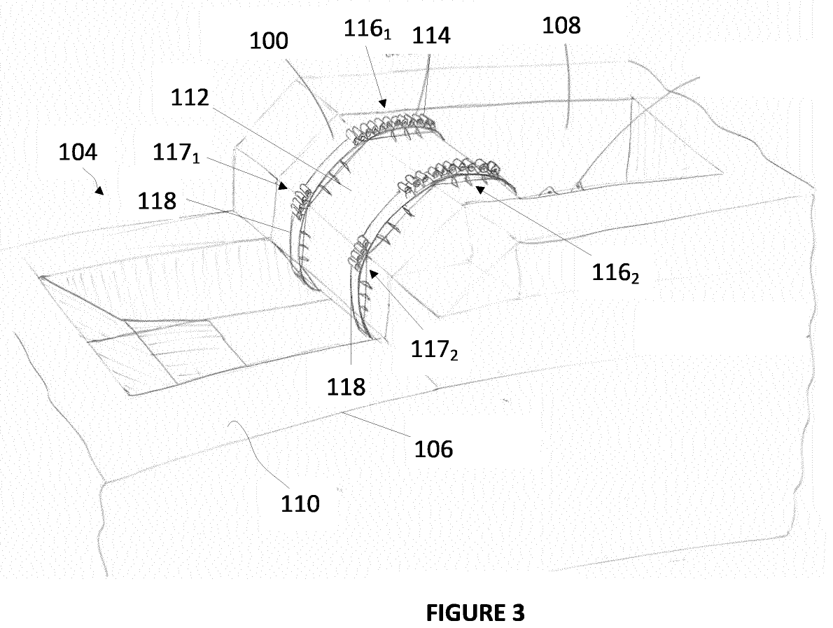

FIG. 3 shows a reel support apparatus 100 for supporting a pipeline storage reel on a vessel 104. The reel support apparatus 100 includes a hub body 112 for locating within a hollow central bore of a pipeline storage reel.

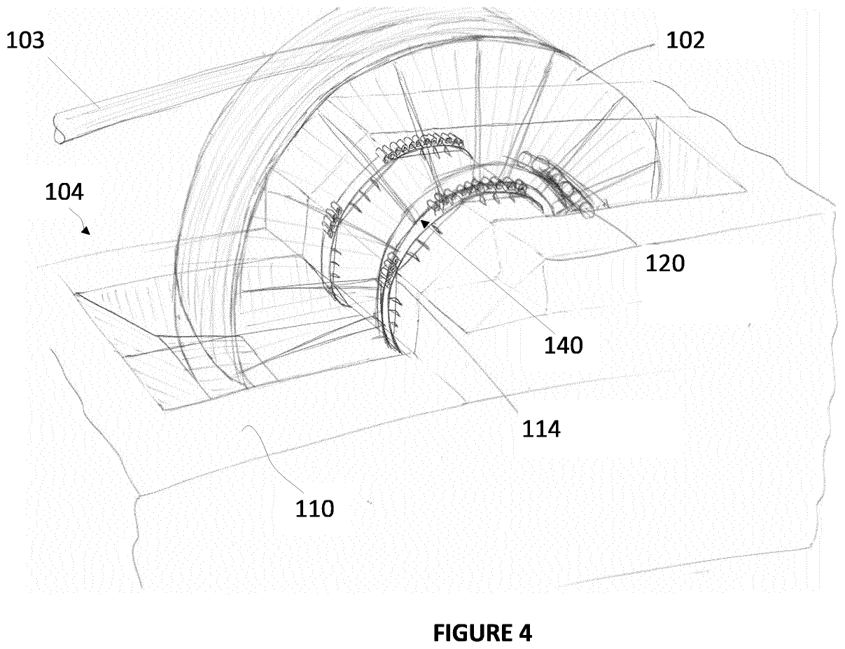

The apparatus 100 is shown in FIG. 4, including a pipeline storage reel 102 (including pipeline 103) mounted thereon. The reel 102 includes a central core (with a hollow central bore 140) for winding pipeline onto, and a flange at each end of the core to help retain the pipeline in place. The pipeline storage reel 102 is provided separately from the hub body 112 (i.e. the hub body 112 does not form part of the pipeline storage reel 102 itself). The hollow central bore 140 of the pipeline storage reel 102 is then mounted onto the hub body 112 of the apparatus.

In this example, the reel 102 is mounted as part of a ‘fixed reel’ arrangement. That is, the hub body 112 and reel 102 are permanently installed on the vessel 104, the reel support apparatus 100 having been mounted on the vessel 104 during the initial construction of the vessel 104 (for example the reel support apparatus 100 is mounted on a support structure on the vessel).

In this example, the apparatus 100 and reel 102 are provided on the vessel in a well or space 108 inset into the deck 110 (i.e. lower than main deck level 106 of the vessel 104). The reel support apparatus 100 further includes a plurality of discrete roller elements 114, spaced apart at locations on an outer surface of the hub body 112. In this example, the roller elements 114 are mounted roller bearings, utilising a suitable rolling means, for example ball, cylindrical or barrel shaped bearings. In other examples, other suitable roller elements 114 configured to support a load may be used.

In this example, each discrete roller element 114 includes a single, mounted, roller bearing (or the like). However, in other examples, each discrete roller element 114 (or one or more of the discrete roller elements 114) may include two, three or more roller bearings. That is, a given roller element 114 may include more than one roller bearing mounted within a single assembly.

The positioning of the roller elements 114 on the outer surface of the hub body 112 is such that the pipeline storage reel can be supported by the plurality of discrete and spaced apart roller elements 114. That is, in use (i.e. when the pipeline storage reel 102 is mounted onto the hub body 112), the weight of the pipeline storage reel 102 is supported by the roller elements 114.

More specifically, the roller bearings of the roller elements 114, provide a roller running surface, positioned radially outwardly from the outer surface of the hub body 112. In use, at least a portion of the bore of the pipeline storage reel 102 is supported on the roller running surface provided by the roller elements 114. As the pipe is deployed from the pipeline storage reel 102 (for example actively drawn or drawn through the self-weight of the deployed pipe), the pipeline storage reel 102 rotates relative to the hub body 112, the bore 140 of the pipeline storage reel 102 rolling over the roller running surface of the roller elements 114. In other words, the rotational axis of the roller elements 114 (i.e. the axis around which the roller bearing(s) of each roller element 114 permit rotation) is parallel to the axis of the hub body 112 and the reel 102, to allow the reel to rotate around the hub body 112.

The roller elements 114 may be fixed or coupled to the outer surface of the hub body 112 in any suitable manner. For example, the roller elements 114 may be bolted or otherwise fixed to the hub body 112. In this example, the hub body 112 includes an optional mounting frame(s) or track(s) 118, onto which the roller elements 114 are mounted. This configuration is particularly useful when the hub body 112 is of a non-cylindrical shape, in which case, a substantially annular or ring shaped mounting frame can be incorporated as part of the hub body 112, to generally correspond to the bore 140 of the pipeline storage reel 102. In addition, the use of a mounting frame 118 makes dimensional control during construction easier as the critical tolerances apply to the smaller mounting frame 118 rather than the whole construction. In other examples, the hub body 112 may be a single integral component without such a mounting frame.

In this example, the plurality of roller elements includes at least one array (i.e. one group or collection) of roller elements 114. At least one of the arrays of roller elements is positioned around an upper face of the hub body 112. In this example, there is a first array 116₁ and a second array 116₂ of roller elements 114 positioned in this way, the arrays 116_{1,2} being located at either end of the hub body 112 (that is, the arrays 116_{1,2} are spaced axially along the length of the hub body 112 and positioned proximal to an end region of the hub body 112).

In this example, the roller elements 114 within each array 116_{1,2} are positioned in an arc over the upper face of the hub body 112. In other words, the roller elements 114 within each array 116_{1,2} are located within the same axial plane of the hub body 112 and are spaced apart circumferentially on the upper face of the hub body 112. In this example, the roller elements within each array 116_{1,2} are distributed or spaced evenly around the upper face of the hub body 112. As such, when supporting the weight of the reel 102, the load is distributed evenly among the roller elements 114.

In this example, the pipe 103 is actively deployed from the pipeline storage reel 102. That is, the pipeline storage reel 102 is rotated to deploy the pipe therefrom. In this example, the pipeline storage reel 102 is actively driven by drive means. In this example, the drive means includes a plurality of drive motors 120.

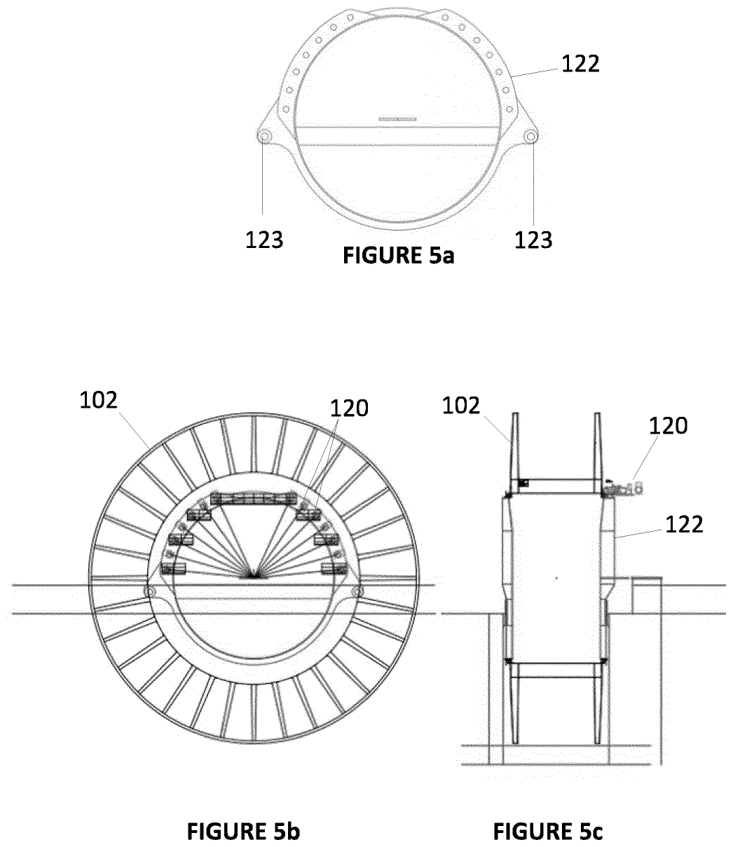

The drive motors 120 are configured to engage with the reel to drive rotation of the reel. In this example, the drive motors 120 are mounted on a drive means mounting element 122, as illustrated in FIGS. 5a to 5c. That is, each drive motor 120 is mounted on the drive means mounting element 122, and then the mounting element 122 is connected or mounted to the vessel. In this example the mounting element 122 is fixed to the vessel 104 via two pin connections 123.

In use, the drive means mounting element 122 is located adjacent to a side of the reel to allow the drive motors 120 to engage with a portion of the reel, for example a radially inner portion of the flange of the reel 102. In this example, each drive motor 120 interacts with the reel via a rack and pinion configuration.

The drive means mounting element 122 may be integral with the hub body 112 (i.e. the mounting element 122 may extend from the hub body 112), or may be a separate component (for example, the mounting element 122 may be substantially annular in profile, with the hub body 112 extending therethrough).

The use of a drive means mounting element 122 to hold the drive motors 120 in place allows the loads from each drive motor 120 to be transferred to the vessel 104 at fewer places and therefore improves the interface between the drive motors 120 and the vessel.

In some examples, the plurality of roller elements 114 includes further roller elements, or arrays of roller elements, in addition to those present in the first and second arrays 116_{1,2}. In this example, the plurality of roller elements 114 includes arrays 117_{1,2} of side roller elements 114 positioned around a side face of the hub body and spaced apart from the corresponding array 116_{1,2} of roller elements.

That is, in this example, the side roller elements 114 are located in the same axial plane (of the hub body 112), but spaced circumferentially from, a corresponding array 116_{1,2}. In this manner, the side roller elements 114 are also mounted on the corresponding mounting frame 118 (where applicable). As with the roller elements in the arrays 116_{1,2}, the rolling axis of the side roller elements are parallel to the axis of hub body 112 and the reel 102 to allow the reel 102 to roll over the side roller elements as it moves around the hub body 112.

The roller elements in these arrays 117_{1,2} help carry horizontal forces from the reel, in particular longitudinal forces. That is, although some of the roller elements 114 within the arrays 116_{1,2} are arranged non-vertically within the arc-arrangement and therefore can carry some longitudinal loads, further side roller elements 114 can provide more targeted longitudinal load-carrying capability.

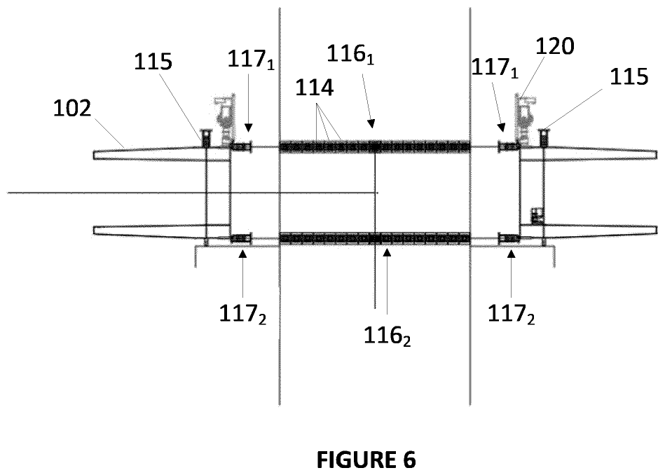

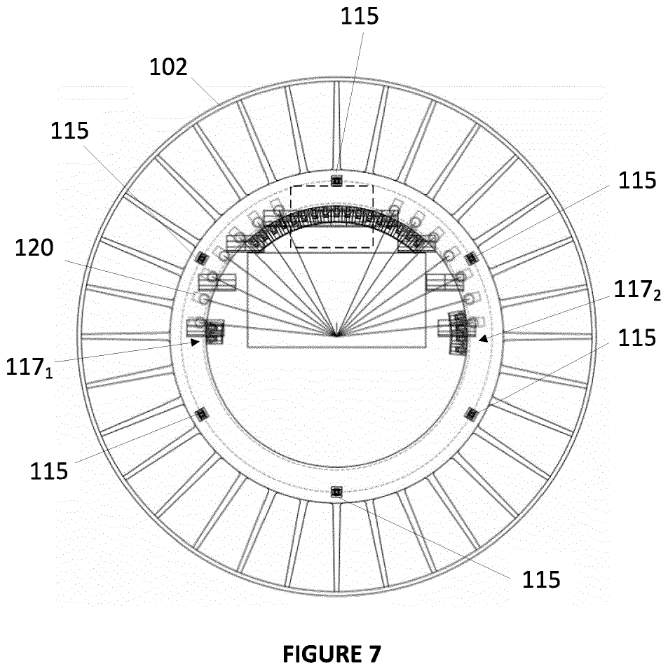

In this example, arrays 117_{1,2} are positioned on both sides of the hub body 112 (although the arrays on the side opposite to the direction of pipe deployment are not visible in FIGS. 3 and 4). The roller elements 114 positioned on the side of the hub body 112 opposite to the direction of pipe deployment are particularly useful in carrying inboard catenary forces. In this example, as best shown in FIGS. 6 and 7, the reel support apparatus 100 includes transverse roller elements 115. The transverse roller elements 115 are configured to carry transverse loads. In particular, the transverse roller elements 115 are configured to support the reel 102 against vessel roll forces or roll acceleration forces.

The transverse roller elements 115 are provided so as to contact a flange of the pipeline storage reel 102. The transverse roller elements 115 are oriented perpendicular to the plurality of roller elements 114. The rolling axis of the transverse roller elements 115 (i.e. the axis around which rotation is supported by the roller elements 115) is arranged parallel with the flange of the reel 102. As such, as reel 102 rotates around the hub body 112, the reel 102 (or more particularly the flange thereof) rolls over the roller bearings of the roller elements 115.

The transverse roller elements 115 may be mounted on any suitable part of the vessel, i.e. any part of the vessel from which the transverse roller elements 115 can contact a flange portion of the reel. For example the transverse roller elements 115 may be mounted on the drive means mounting element 122.

In this example at least one of the roller elements 114 is supported by a support element that is extendable or retractable to different positions, in particular different radial positions with respect to the hub body 112. In other words, each roller element 114 (or the roller bearing(s) within each roller element) is radially movable with respect to the hub body 112. In this example each roller element 114 is supported by a separate support element, such that the radial position of each roller element 114 may vary independently.

By allowing each roller element 114 to move radially with respect to the hub body 112, the position of each roller element 114 can be adjusted to more effectively distribute the load from the reel across the arrays of roller elements. That is, the roller surface provided by the roller elements can conform to the bore 140 of the reel 102.

Any suitable support element may be used. For example, the support element may be a mechanical support, including a fixed mount, a screw jack, a wedge or a spring. In this example each support element is a hydraulic actuator (or hydraulic jack).

In this example, a first end of the hydraulic actuator is fixed (for example to the mounting frame 118 or the hub body 112) and a second end, coupled to the corresponding roller element 114 is movable with respect to the fixed end. That is, the length of the hydraulic actuator may be changed to vary the radial position of the corresponding roller element 114. The hydraulic actuator may be extendable to a shimmed extension limit to provide a tolerance running position. In some examples the support element may be integral with the corresponding roller element 114 (that is, the support element may be provided as part of the roller element 114).

The support elements may be biased to their extended positions. As such, the roller surface can self-adjust when the weight of the reel becomes concentrated on a particular area of the roller surface. For example, movement of the vessel or deployment of the pipe may result in forces on the roller elements, which temporarily acts against the bias of the corresponding support element.

The reel support apparatus may further include at least one support face configured to support the pipeline storage reel 102 when the support element of a corresponding roller element is in a retracted position (i.e. in a fully retracted position whereby the roller element, or the roller bearing(s) of the roller element is positioned below the outer surface of the hub body 112). In this manner, in certain situations (for example during transit), the support elements may be manually retracted, such that the bore of the reel is supported by the support faces rather than the arrays of roller elements 116_{1,2}. In other words, retraction of the support elements disengages the reel 102 from the bore. For example, when using a hydraulic actuator as a support element, the hydraulic fluid can be drained (for example temporarily) to retract the support element.

The support faces may be positioned adjacent to a corresponding roller element of the arrays 116_{1,2}. Alternatively the support faces may be integral within each roller element (that is, the support face may be part of the roller element, positioned adjacent to the roller bearing(s) of said roller element).

Supporting the reel on the outer surface of the hub body 112 in this way removes the risk of false Brinnel during survival or transit. For example, when transporting a full reel, loads induced in survival conditions are not carried by the roller elements. This lowers the risk of unexpected overload.

The support faces may be shaped or contoured to conform with the inner surface of the reel bore. The support faces may be located on the outer surface of an integral hub body, or on a mounting frame incorporated as part of the hub body depending on the configuration of the hub.

In some examples, the hydraulic actuators may be connected to an accumulator. In such examples, the accumulator may provide a pre-defined spring rate to help load distribution on the roller elements. In some examples, the hydraulic actuators may be connected to a relief valve. In such examples the relief valve may limit the force that may be imparted to an individual roller bearing, preventing damage in the case of unexpected loading.

In some examples, one or more of the transverse roller elements 115 may also include support elements in the same manner as described above. In such examples, at least one of the support elements may act to bias the reel towards a central position and help resist vessel roll and roll acceleration. This allows more relaxed fabrication tolerances on the reel width.

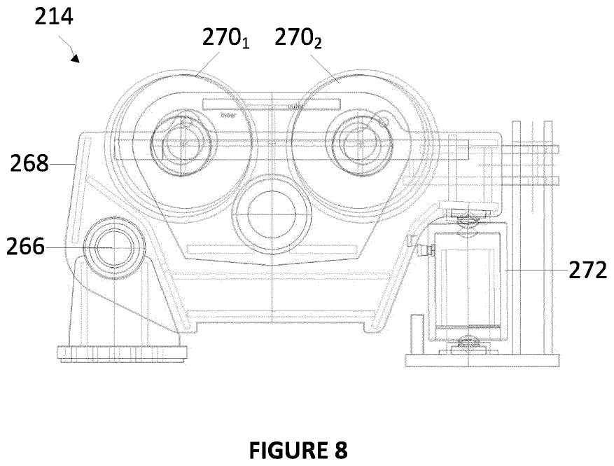

FIG. 8 illustrates an alternative roller element 1. In this example, the roller element 214 includes two rollers or roller bearings 270_{1,2} mounted within frame or mount 268. In this example, the roller element 214 includes a hydraulic actuator as a support element 272, provided integrally within the roller element 214. The extension or retraction of the support element 272 controls the radial position of both roller bearing elements 270_{1,2} with respect to the hub body 112 by pivoting the frame 268 around pivot 266.

Various modifications to the detailed arrangements as described above are possible. For example, although positioning the arrays 116_{1,2} at the ends of the hub body 112 is particularly beneficial (as this corresponds to the strongest part of the hub body) the arrays may be otherwise axially positioned on the hub body 112. The reel support apparatus may also include any number of arrays spaced axially along the outer surface of the hub body. Each array may include any suitable number of roller elements.

The roller elements 114 within each array may be spaced by any suitable amount. For example, adjacent roller elements may be substantially abutting (although without direct contact between the roller bearings of adjacent roller elements to allow free rotation).

With regards to the side roller elements, there may be any number of side roller elements on each side of the hub body. For example, a side of the hub body 112, or both sides of the hub body may include an array of side elements including 0, 1, 2, 3 or more side elements (at a particular axial location). In some examples, a first side of the hub body 112 may include more side roller elements than the opposing side. This may be due to an expectation that a particular side of the hub body 112 may experience larger forces, for example the side of the hub body 112 opposite to the direction of pipe deployment may be required to carry inboard catenary forces and therefore may require a larger number of side roller elements than the opposing side. For example, as shown in FIG. 7, one side of the hub body 112 includes an array of side roller elements including two side roller elements, whereas the other side of the hub body 112 (the side opposite to the direction of pipe deployment) includes an array of side roller elements including four side roller elements.

The roller elements used in different parts of the reel support apparatus (for example the roller elements in the arrays 116_{1,2}, the side roller elements, the transverse roller elements etc.) may all be the same or they may differ depending on the load requirements (for example the peak expected load). Similarly, where applicable, the support elements associated with each roller may be the same or different.

In some examples, the reel support apparatus may further include a central bearing, centrally provided within the hub body at a distance from the roller elements. In other words, a central bearing may be provided around the hub body, the central bearing being spaced axially from the roller elements along the length of the hub body. The central bearing may provide additional support to the reel, for example to compliment the support provided by the roller elements.

With the above arrangements, a reel assembly is provided that has improved resistance to wear or damage compared to known reels. The loads experienced by the reel are shared over the roller elements over a wider area (compared to a previously known reel that relied on a single bearing surface at each end of the reel). With this, the magnitude of the force carried by each roller element, trackway, bearings and support structure is reduced. In addition, the connection between the reel support structure and the vessel deck is more distributed and dispersed, giving a lower weight connection and which is less susceptible to small deflections and movements in the vessel.

With the above arrangements, the connection between the reel support apparatus and the vessel is such that the weight of the reel support apparatus (and reel mounted thereon) is more distributed and therefore results in lower stress and a reduced susceptibility to small deflections and movements in the vessel. That is, the hub body of the reel support apparatus is supported by the vessel. This is in contrast to typical arrangements where the reels are supported by bearings, which are in turn supported by the vessel (i.e. the bearings provide the interface between the reel and the vessel).

With the above arrangements, the reel support apparatus is better suited to storing larger capacity pipes than conventional designs. Specifically, providing a fixed arrangement with distributed support allows the weight to be distributed over a greater number of components, whereas in conventional designs, the pipe weight is supported by a pair of bearings (at either end). At higher capacities finding suitable single bearings can be difficult.

The use of a support element, which can alter the radial position of a corresponding roller element, allows the load to be shared effectively. That is, in response to a concentration of force on a particular roller element/roller elements, the radial position of said roller element(s) will self-moderate to ensure the load is shared effectively. In addition, in the event of a force overload the roller automatically relieves, limiting the force, rather than damaging the roller, trackway or support bearings. This differs from traditional central hub bearings in which forces are determinate and load share is not possible.

The structure through the reel hub area may be more easily closed from a water flooding event, thereby reducing the volume of the reel well in damage stability.

The arrangement may also avoid the need for regular turning of the reel while the vessel is travelling, and the associated problems that can bring, as per prior art systems.

Some or various individual roller elements may be repaired while at sea, if necessary. A damaged roller may be repaired even when the reel is carrying a full load of pipeline, without a heavy-lift crane support. That is, a roller element may be retracted away from the reel using the corresponding hydraulic actuator, which allows the roller element to be removed. Thereby, the reel assembly may be maintained while out at sea, which has previously not been possible. Also, the plurality of roller elements have a built in redundancy, whereby the reel may continue to be operational, even if one or two roller elements are damaged. It will be clear to a person skilled in the art that features described in relation to any of the embodiments described above can be applicable interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A reel support apparatus for supporting a pipeline storage reel on a vessel, comprising:
a hub body for locating within a hollow central bore of a pipeline storage reel,
a plurality of discrete roller elements, spaced apart at locations on an outer surface of the hub body,
wherein, in use, a pipeline storage reel is supported by the plurality of discrete and spaced apart roller elements.

2. An apparatus as claimed in claim 1, wherein the plurality of roller elements includes at least one array of roller elements, positioned around an upper face of the hub body.

3. An apparatus as claimed in claim 2, wherein the at least one array of roller elements is positioned in an arc configuration.

4. An apparatus as claimed in claim 2, the plurality of roller elements comprising side roller elements, positioned around a side face of the hub body and spaced apart from the at least one array of roller elements.

5. An apparatus as claimed in claim 1, the reel support apparatus further comprising at least one transverse roller element configured to support the reel against vessel roll forces.

6. An apparatus as claimed in claims 1, wherein at least one of the plurality of roller elements is supported by a support element that is extendable or retractable to different positions.

7. An apparatus as claimed in claim 6, wherein the support element is a mechanical support, comprising a fixed mount, a screw jack, a wedge, a spring or a hydraulic actuator.

8. An apparatus as claimed in claim 6, the reel support apparatus further comprising a support face adjacent to each roller element of the at least one array, wherein the support face is configured to support the pipeline storage reel when the support element of the corresponding roller element is in a retracted position.

9. An apparatus as claimed in claim 1, wherein the reel support apparatus further comprises drive means configured to rotate the pipeline storage reel.

10. An apparatus as claimed in claim 9, wherein the drive means includes a plurality of drive motors mounted on a mounting element, the mounting element being connected to the vessel.

11. An apparatus as claimed in claim 1, wherein the reel support apparatus further includes a central bearing, centrally provided within the hub body at a distance from the roller elements.

12. A system for storing marine pipeline on the deck of a vessel, comprising:
a storage reel for storing marine pipeline, the reel comprising a hub and flanges at each end; and
a reel support apparatus according to claim 1,
wherein the hub body of the reel support apparatus is provided within a hollow central bore of the storage reel, the storage reel being supported by the roller elements of the reel support apparatus.

13. A vessel comprising a system as described in claim 12.

14. A method of supporting a pipeline storage reel on a vessel, the method comprising:
providing a reel support apparatus according to claim 1;
mounting the hollow central bore of a pipeline storage reel onto the hub body of the apparatus, the pipeline storage reel being supported by the plurality of discrete and spaced apart roller elements.
